(19) United States
(12) Patent Application Publication
(10) Pub. No.: US 2026/0323158 A1
(43) Pub. Date: Oct. 15, 2026

(54) MEDIA DATA TRANSMISSION METHOD, TRANSMISSION CONTROL SYSTEM AND STORAGE MEDIUM

(71) Applicant: SZ DJI TECHNOLOGY CO., LTD., Shenzhen (CN)

(72) Inventors: Yanqiang LI, Shenzhen (CN); Haofan NIU, Shenzhen (CN)

(73) Assignee: SZ DJI TECHNOLOGY CO., LTD., Shenzhen (CN)

(21) Appl. No.: 19/688,638

(22) Filed: May 27, 2026

Related U.S. Application Data
(63) Continuation of application No. PCT/CN2023/134507, filed on Nov. 27, 2023.

(51) Int. Cl. H04N 23/661; G06T 1/60

(52) U.S. Cl. CPC H04N 23/661; G06T 1/60

(57) ABSTRACT

A media data transmission method is provided, applied to a first application module of a mobile terminal, the mobile terminal further includes a second application module communicatively connected to the first application module, the first application module is configured to communicate with a media data obtaining apparatus, and the media data transmission method includes: in response to generation of media data by the media data obtaining apparatus, receiving the media data generated by the media data obtaining apparatus; and automatically sending the media data to the second application module of the mobile terminal, where a data access permission of the second application module is higher than that of the first application module. When the media data obtaining apparatus generates new media data, the first application module automatically sends the received media data to the second application module of the mobile terminal.

### RELATED APPLICATIONS

This application is a continuation application of PCT application No. PCT/CN2023/134507, filed on Nov. 27, 2023, and the content of which is incorporated herein by reference in entirety.

### TECHNICAL FIELD

The present disclosure relates to the technical field of media data transmission, and in particular, to a media data transmission method, a media data transmission control system, and a storage medium.

### BACKGROUND

At present, with the improvement of people's living standards, photographing has become one of indispensable needs in daily life. Although smartphones can implement a photographing function, limitations of their device parameters often make them inadequate for scenarios that demand high image quality. In other words, photos taken by the smartphones can meet daily photographing needs, but fail to provide sufficient details for users to perform post-processing.

A large sensor installed on a photographing apparatus such as a camera can better capture details and has a superior exposure control capability. Therefore, the photographing apparatus such as the camera can produce more professional photos. However, the camera relies on a memory card to store a photo that is taken. When a user needs to process the photo stored in the memory card, the user needs to remove the memory card first and then transmits data in the memory card to a device such as a computer for processing, which is quite cumbersome.

Currently, there are also solutions available for transmitting the photo taken by the camera to a mobile phone for immediate processing. For example, a connection between the camera and the mobile phone can be established through a camera application (App) on the mobile phone. Nevertheless, the photo taken by the camera still needs to be manually downloaded to the mobile phone by the user through the camera App. Furthermore, the camera App must remain open during use. This greatly affects user experience.

### SUMMARY

The present disclosure provides a media data transmission method, a media data transmission control system, and a storage medium to solve at least one of the above technical problems.

According to a first aspect, the present disclosure provides a media data transmission method, including: generating, by a media data obtaining apparatus, media data, where the media data transmission method is applied to a first application module of a mobile terminal, the mobile terminal further includes a second application module, the second application module is communicatively connected to the first application module, and the first application module is configured to communicate with the media data obtaining apparatus; in response to the generating of the media data, receiving the media data; and automatically sending the media data to the second application module of the mobile terminal, where a data access permission of the second application module is higher than a data access permission of the first application module.

According to a second aspect, the present disclosure provides a media data transmission method, including: obtaining a media data obtaining instruction from a user, and generating media data, where the media data transmission method is applied to a media data obtaining apparatus, the media data obtaining apparatus communicates with a first application module of a mobile terminal, and the first application module is communicatively connected to a second application module of the mobile terminal; sending the media data to the first application module of the mobile terminal; and automatically transmitting, by the first application module, the media data to the second application module, where a data access permission of the second application module is higher than a data access permission of the first application module.

According to a third aspect, the present disclosure provides a media data transmission control system, including: at least one storage medium storing at least one set of instructions; and at least one processor in communication with the at least one storage medium, where during operation, the at least one processor executes the at least one set of instructions to cause the media data transmission control system to perform at least one of Process A or Process B: Process A: generating, by a media data obtaining apparatus, media data, where the media data transmission method is applied to a first application module of a mobile terminal, the mobile terminal further includes a second application module, the second application module is communicatively connected to the first application module, and the first application module is configured to communicate with the media data obtaining apparatus; in response to the generating of the media data, receiving the media data; and automatically sending the media data to the second application module of the mobile terminal, where a data access permission of the second application module is higher than a data access permission of the first application module; Process B: obtaining a media data obtaining instruction from a user, and generating media data, where the media data transmission method is applied to a media data obtaining apparatus, the media data obtaining apparatus communicates with a first application module of a mobile terminal, and the first application module is communicatively connected to a second application module of the mobile terminal; sending the media data to the first application module of the mobile terminal; and automatically transmitting, by the first application module, the media data to the second application module, where a data access permission of the second application module is higher than a data access permission of the first application module.

In the media data transmission method in the present disclosure, when a media data obtaining apparatus generates new media data, a first application module of a mobile terminal can automatically send the received media data to a second application module of the mobile terminal. Therefore, a user does not need to manually select to-be-downloaded media data in the first application module, and any media data generated on the media data obtaining apparatus can be automatically downloaded to the second application module. Since a data access permission of the second application module is higher than that of the first application module, a media data processing App of the mobile terminal can directly access media data on the second application module, thereby improving user experience.

Additional aspects and advantages of the present disclosure are to be partially provided in the following description, and partially become evident in the following description, or are understood through the practice of the present disclosure.

### BRIEF DESCRIPTION OF THE DRAWINGS

The foregoing and/or additional aspects and advantages of the present disclosure will become apparent and easy to understand from the description with reference to the following accompanying drawings.

FIG. 1 is a schematic diagram of media data transmission in the related art.

FIG. 2 is a schematic diagram of a partial structure of a media data transmission apparatus according to the present disclosure.

FIG. 3 is a flowchart of a media data transmission method according to the present disclosure.

FIG. 4 is a schematic flowchart of a media data transmission method according to the present disclosure.

FIG. 5 is a schematic diagram of data transmission in a media data transmission method according to the present disclosure.

FIG. 6 is a schematic diagram of data transmission in a media data transmission method according to the present disclosure.

FIG. 7 is a schematic diagram of data transmission in a media data transmission method according to the present disclosure.

FIG. 8 is a schematic diagram of data transmission in a media data transmission method according to the present disclosure.

FIG. 9 is a schematic diagram of data transmission in a media data transmission method according to the present disclosure.

FIG. 10 is a schematic diagram of a logical structure of a media data transmission control system according to the present disclosure.

### REFERENCE NUMERALS OF MAIN COMPONENTS

10: media data obtaining apparatus;
20: mobile terminal;
201: first application module; 2011: first display bar, 203: second display bar; 2011a (2031): first identifier; 2011b (2032): second identifier; 2011c (2033): third identifier; 202: second application module; 203: third application module;
100 (200): media data transmission control system; 210: memory; 220:
processor.

### DETAILED DESCRIPTION

In the description of the present disclosure, some of the publicly disclosed examples have been shown accordingly in the accompanying drawings. The same or similar numerals represent the same or similar elements or elements having the same or similar functions throughout the disclosure. The content described below with reference to the accompanying drawings is exemplary, and is merely intended to explain the present disclosure, rather than to limit the present disclosure.

In the description of the present disclosure, a number of different cases or examples are disclosed to implement different structures of the present disclosure. To simplify the disclosure of the present disclosure, components and dispositions of particular examples are described below. Certainly, the descriptions are only examples and are not intended to limit the present disclosure.

At present, with the improvement of people's living standards, photographing has become one of indispensable needs in daily life. Although smartphones can implement a photographing function, limitations of their device parameters often make them inadequate for scenarios that demand high image quality. In other words, photos taken by the smartphones can meet daily photographing needs, but fail to provide sufficient details for users to perform post-processing.

A large sensor installed on a photographing apparatus such as a camera can better capture details and has a superior exposure control capability. Therefore, the photographing apparatus such as the camera can produce more professional photos. However, the camera relies on a memory card to store a photo that is taken. When a user needs to process the photo stored in the memory card, the user needs to remove the memory card first and then transmits data in the memory card to a device such as a computer for processing, which is quite cumbersome.

Currently, there are also solutions available for transmitting the photo taken by the camera to a mobile phone for immediate processing. For example, a connection between the camera and the mobile phone can be established through a camera App on the mobile phone. Nevertheless, the photo taken by the camera still needs to be manually downloaded to the mobile phone by the user through the camera App. Furthermore, the camera App must remain open during use. This greatly affects user experience.

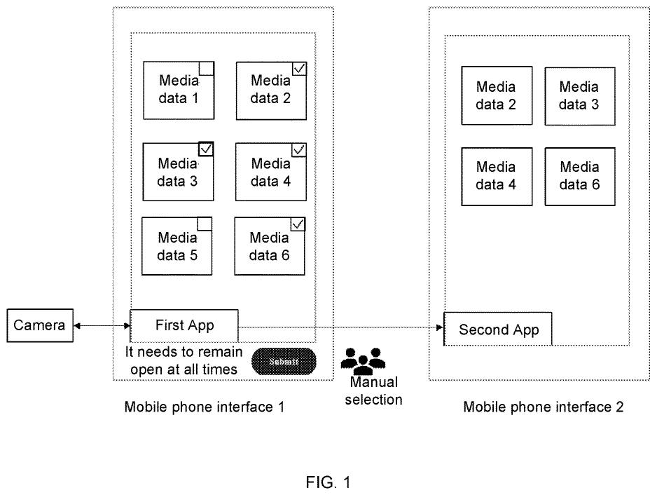

Specifically, reference is made to a media data transmission scheme in the related art, as shown in FIG. 1.

A connection is established between a camera and an App through Bluetooth and wireless fidelity (WIFI). After the camera takes a new photo and transmits it to the App, a user still needs to manually select and download a desired new photo to a system album. In addition, the App needs to remain in a foreground at all times when the user manually selects and downloads the desired new photo. As a result, the user is unable to use a mobile phone to perform other tasks. Furthermore, the App needs to remain open at all times, and current mobile phones are mostly touch-screen phones. As a result, accidental touches are likely to occur when the user takes a photo with the camera and places the mobile phone in an accommodating apparatus such as a pocket, thereby causing poor user experience.

Additionally, it should be noted that in the related art, due to a format limitation of media data transmitted by the camera to a first application module, the media data occupies a relatively large memory space. Therefore, for a person skilled in the art, only media data selected by the user is generally downloaded to the system album.

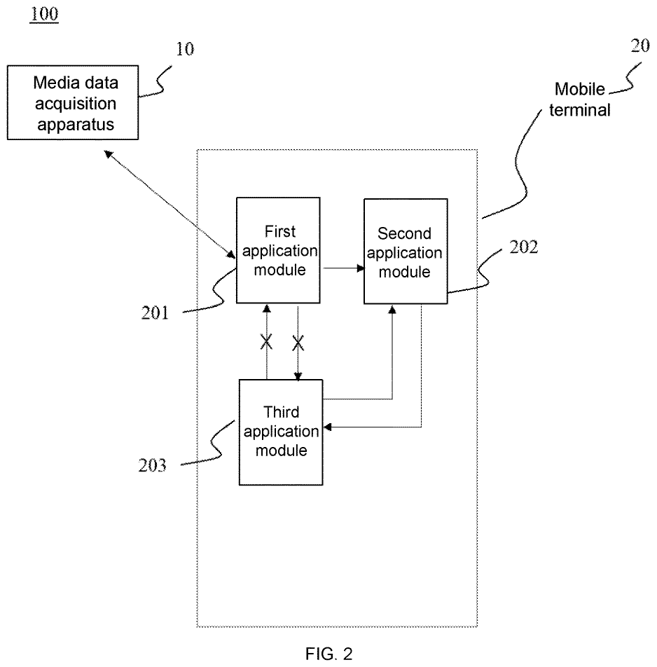

Therefore, the present disclosure proposes a media data transmission method. Reference is made to a schematic diagram of a partial structure of a media data transmission apparatus in FIG. 2. The media data transmission method in the present disclosure is applied to a first application module 201 of a mobile terminal 20. The media data transmission apparatus 100 further includes a media data obtaining apparatus 10. The mobile terminal 20 includes the first application module 201 and a second application module 202 communicatively connected to the first application module, and the first application module 201 communicates with the media data obtaining apparatus 10. In some implementations, a communication mode between the first application module 201 and the media data obtaining apparatus 10 is wireless communication. In this way, complexity of transmission in a wired mode is avoided, thereby improving convenience of media data transmission.

In some implementations, the media data obtaining apparatus 10 may be an image obtaining apparatus, which is configured to generate or take a picture, a video, and the like. The media data obtaining apparatus 10 may alternatively be an audio obtaining apparatus, such as a recording apparatus or a sound pickup apparatus.

In some implementations, the image obtaining apparatus or the audio obtaining apparatus may be mounted on any movable object. The movable platform may be an aircraft, an unmanned aerial vehicle (UAV), a ground mobile robot, an unmanned vehicle, a smart robot, an aquatic robot, an aerial robot, or the like. The image obtaining apparatus may be a camera that is classified based on an application scenario and needs to transmit obtained media data to the mobile terminal for processing, such as a digital camera, an action camera, or a pocket camera. This is not limited in the present disclosure.

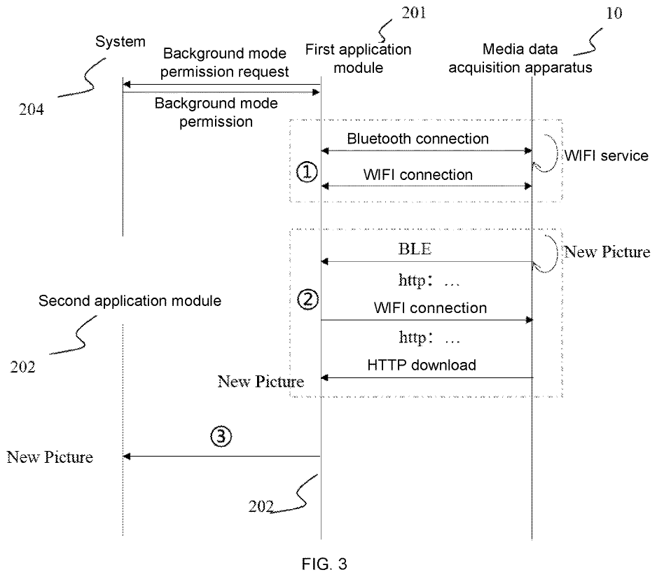

In some implementations, the mobile terminal 20 may be a smart electronic component with a display device, for example, may be a smartphone or a smart watch. The first application module 201 is specially configured to establish a connection with the media data obtaining apparatus 10, so as to control the media data obtaining apparatus or manage and edit data obtained by the media data obtaining apparatus. If the media data obtaining apparatus is the digital camera, the first application module 201 may be a digital camera App. Furthermore, a private communication connection is established between the first application module and the media data obtaining apparatus, so as to ensure communication security between the media data obtaining apparatus and the first application module. Still furthermore, data of the first application module cannot be accessed by other Apps in the mobile terminal than a system App, thereby ensuring data security. In some implementations, referring to FIG. 3, the first application module 201 and the media data obtaining apparatus 10 are connected through Bluetooth, and a WIFI connection is established through a WIFI service.

In some implementations, the second application module 202 is configured to transfer and obtain data that cannot be obtained by the other Apps in the mobile terminal, such that a user can use the other Apps to process data in a professional App (such as the digital camera App). In some implementations, the second application module 202 is a system album of the mobile terminal. It can be understood that media data in the system album can be accessed by any other App of the mobile terminal. In other words, an access permission of data in the system album by the other Apps is higher than that of the digital camera App. It can be understood that a data permission of an App can be set when the App is installed on the mobile terminal, but a permission granted to the system App for the user is higher than that granted to a third-party App. Third-party Apps usually do not open permissions to each other due to data security. Due to data transmission security, the user has poor interaction experience. The solution proposed in the present disclosure can exactly improve user experience while ensuring the data transmission security.

In some implementations, the mobile terminal 20 further includes a third App 203. The third App 203 is configured to access, edit, or process media data in the second application module. For example, the third App 203 is Meitu Xiuxiu, which allows the user to quickly access media data transmitted by the first application module and stored in the second application module, and to edit or process the media data. When the media data is a picture or a video, the user can edit or process at least one of exposure, contrast, brightness, saturation, color temperature, sharpening, special effects, filters, a stabilization indicator, and beautification parameters of the picture or the video. The beautification parameters may include face slimming information, skin smoothing information, whitening information, eye enlargement information, a ruddy degree, and the like. In some implementations, the third App 203 may be an audio editor, which enables the user to quickly access the media data transmitted by the first application module and stored in the second application module, and to edit or process the media data. When the media data is audio data, equalizer, compression, reverberation, pitch adjustment, and other functions of the audio editor can be used to edit volume, panning, equalization, and other parameters of the audio data. It can be understood that the third App 203 cannot directly access the data of the first application module.

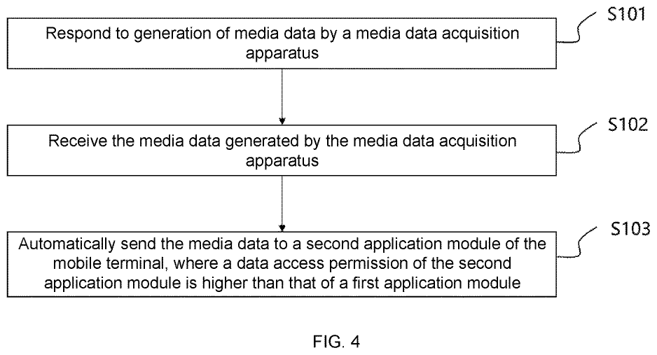

Reference is made to a flowchart of a media data transmission method shown in FIG. 4. The media data transmission method is applied to a first application module of a mobile terminal, and includes the following steps:
S101: Respond to generation of media data by a media data obtaining apparatus.
S102: Receive the media data generated by the media data obtaining apparatus.
S103: Automatically send the media data to a second application module of the mobile terminal, where a data access permission of the second application module is higher than that of a first application module.

In some implementations, upon detecting that new media data is generated on a side where the media data obtaining apparatus is located, for example, when a user takes a new photo using the media data obtaining apparatus, after receiving the new media data, the first application module automatically sends the media data to the second application module. Specifically, the media obtaining apparatus is a camera, the mobile terminal is a mobile phone, the first application module is a camera App, and the second application module is a system album of the mobile phone. It should be noted that the camera App in the present disclosure is not a built-in system camera App of the mobile phone, but an App for controlling third-party hardware (e.g., a digital camera and an action camera).

It can be understood that the data access permission of the second application module is higher than that of the first application module. For example, in the above implementations, a data access permission of the system album of the mobile phone is higher than that of the third-party hardware App (namely, the first application module in the present disclosure). Furthermore, other Apps are able to access media data in the system album of the mobile phone, but cannot access media data of the third-party hardware App. Accordingly, data security of a third-party data App can be ensured.

Furthermore, reference is made to a schematic diagram of a media data transmission method shown in FIG. 3.

The media data obtaining apparatus 10 first establishes a connection with the first application module 201. Specifically, the connection may be established through Bluetooth connection and WIFI connection. In a specific implementation process, the first application module 201 may be allowed to obtain Bluetooth and WIFI permissions when the first application module 201 is installed or opened, and the first application module 201 may be permitted to establish data communication with the media data obtaining apparatus 10.

When generating a new picture, the media data obtaining apparatus 10 sends a notification in a Bluetooth low energy (BLE) mode to inform the first application module of the generation of the new picture and sends a download address (e.g., http: . . . as shown in the accompanying drawings). The first application module then sends a download request to the media data obtaining apparatus based on the download address through WIFI, such that the new picture is downloaded to the first application module. It should be noted that data connection and transmission in this implementation can be completed in a background.

After downloading the new picture, the first application module automatically transmits the new picture to the second application module, such that other Apps can invoke the new picture from the second application module.

Furthermore, still referring to FIG. 3, the first application module 201 can obtain a background running permission of the mobile terminal. In some implementations, before the step S102, the first application module 201 can obtain the background running permission of the mobile terminal. In some implementations, the first application module 201 obtains the background running permission of the mobile terminal when being installed on the mobile terminal. Specifically, the first application module 201 sends a background mode permission request to a system side of the mobile terminal, and the system side returns a background mode permission to the first application module, such that the first application module can run in the background without affecting its data transmission. It can be understood that a reason why the first application module in this implementation can run in the background is that it is mainly configured to download and automatically transmit the media data, without controlling a hardware device to assist the media data obtaining apparatus in obtaining the media data. For example, in a scenario where photographing is performed using a remote controller, a mobile phone, and a UAV, an App in the mobile phone for controlling the UAV to take a photo is not the first application module in this implementation. The App needs to control a camera on the UAV to implement a photographing function, and thus cannot run in the background. That is, in this implementation, an implementation in which the first application module runs in the background is mainly applied to the digital camera, the action camera, a pocket camera, and other devices. In some implementations, a media data transmission system includes a camera and a mobile phone. The mobile phone includes a system, a system album, and a camera App. When the App is installed or used for photo transmission, the App sends a background mode permission request to the system, and the system sends background mode permission to the App. At this time, the user may select or unselect options of automatically downloading the new photo in the background and automatically transmitting the new photo to a second App in the App. In this implementation, it is defaulted that the user has granted permissions to the options of automatically downloading the new photo in the background and automatically transmitting the new photo to the second App in the App. Then, Bluetooth/WIFI connections are established between the camera and the App. In some exemplary embodiments, after the connections are completed, the App can run in the background. The user may select or unselect an option of automatically downloading a photo to the App in the camera. When the user selects the option of automatically downloading the photo to the App in the camera, after the user takes a new photo with the camera, the camera sends a download address of the new photo to the App through Bluetooth. The App downloads the new photo through WIFI, such that the camera transmits a photo file to the App. Thereafter, the App automatically writes the new photo file into the system album of the mobile phone. Alternatively, when the user unselects the option of automatically downloading the photo to the App in the camera, after the user selects batch files on the camera, the selected files can be synchronized to the App on a mobile phone side with one key and then transmitted to the system album of the mobile phone.

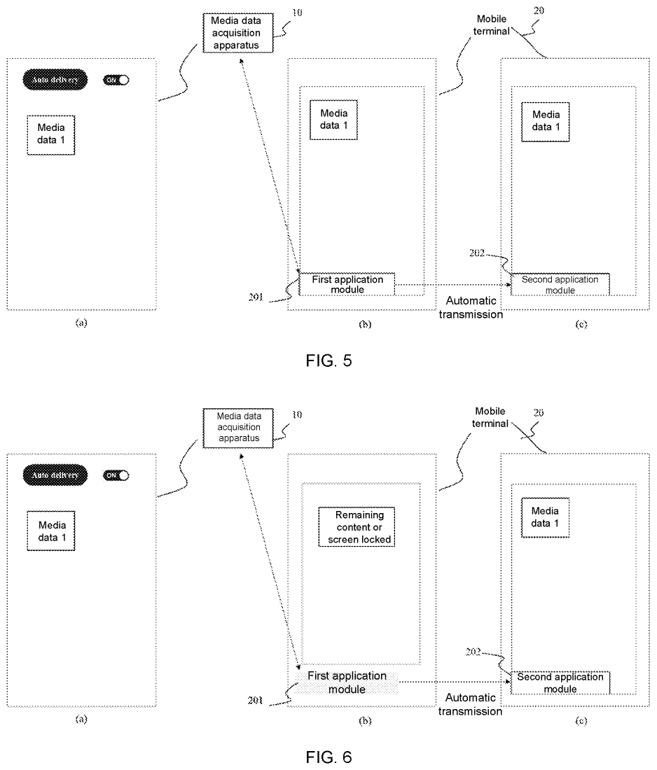

Specifically, reference is made to a schematic diagram of a media data transmission method shown in FIG. 5. FIG. 5(a) shows a display interface of the media data obtaining apparatus, which specifically includes an automatic transmission function and a status key thereof. FIG. 5(b) shows a display state of media data 1 when the first application module of the mobile terminal is in a foreground. FIG. 5(c) shows a display state of the media data 1 when the second application module of the mobile terminal is enabled, where the first application module automatically transmits the media data to the second application module. It should be understood that this figure is for illustrative purposes only and does not constitute a limitation on the scope. In some implementations, when the automatic transmission function is enabled, the S102 may further include the following substep:
S1021: Automatically receive the media data generated by the media data obtaining apparatus.

To ensure that the new picture generated by the media data obtaining apparatus 10 can be rapidly transmitted to the first application module 201 without requiring the user to perform subsequent picture transmission, in this implementation, the first application module 201 automatically receives the media data generated by the media data obtaining apparatus without receiving any user instruction on the first application module. In this way, the user does not need to make any additional selection, and the third-party hardware App does not need to be in the foreground either. Specifically, as shown in FIG. 6, when being in a background state, the first application module can receive the media data sent by the media data transmission apparatus and automatically transmit the media data to the second application module. It should be noted that a gray color in a block diagram of the first application module herein indicates that the first application module is in the background state. Specifically, FIG. 6(a) shows a display interface of the media data obtaining apparatus, which specifically includes an automatic transmission function and a status key thereof. FIG. 6(b) shows a display state of the media data 1 when the first application module of the mobile terminal is in the background (that is, during actual transmission, data transmission can also be completed when the interface shown in FIG. 6(b) is not set on the mobile terminal). FIG. 6(c) shows the display state of the media data 1 when the second application module of the mobile terminal is enabled, where the first application module automatically transmits the media data to the second application module. In some implementations, the first application module can also complete the above data transmission when the mobile phone is in a screen-locked state. That is, in this implementation, the photo can be synchronized to the system album when the first application module (third-party hardware App) is in the background or in the screen-locked state, thereby enabling the user to focus on camera photographing.

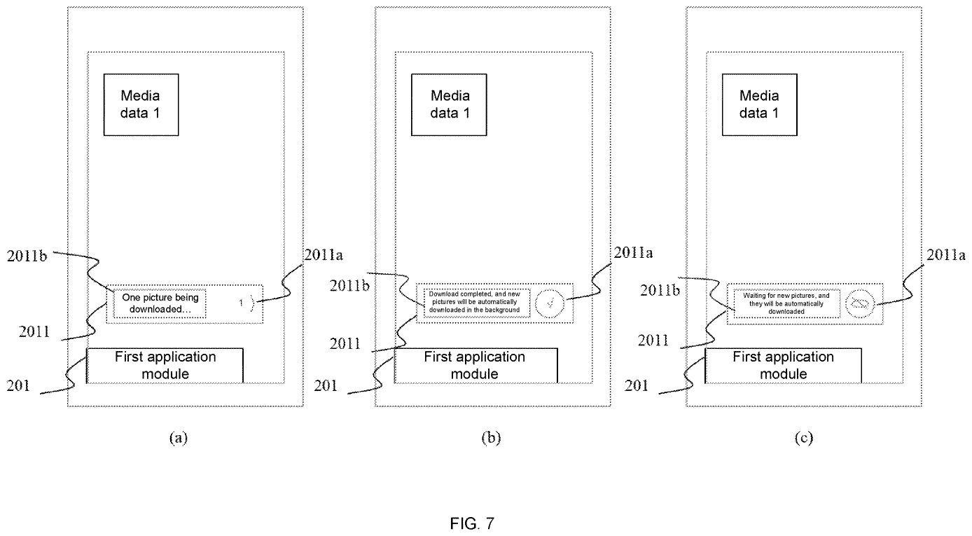

In some implementations, the mobile terminal displays an execution progress of media data transmission. FIG. 7 is a schematic diagram of a real-time activity during download and synchronization when the first application module is in the foreground. More specifically, when the first application module runs in the foreground of the mobile terminal, the execution progress is displayed in a first display manner. For example, as shown in FIG. 7, the first display manner includes a first display bar 2011 displayed on the first application module 201. The first display bar 2011 is configured to specifically display the execution progress of the media data transmission when the first application module 201 is in the foreground. Specifically, the first display bar 2011 includes a first identifier 2011a and a second identifier 2011b. The first identifier 2011a corresponds to different symbols based on different states of the execution progress of the media data transmission. The second identifier 2011b corresponds to the first identifier 2011a and is configured to display text content corresponding to an execution progress symbol of the first identifier 2011a. In some implementations, FIG. 7(a) schematically shows a state of the media data transmission performed by the mobile terminal. When the first identifier 2011a is in an open state (displaying a quantity X of pictures being downloaded), the second identifier 2011b displays “X pictures being downloaded . . . ”. FIG. 7(b) schematically shows a state of the media data transmission performed by the mobile terminal. When the first identifier 2011a is in a checked state, the second identifier 2011b displays “Download completed, and new pictures will be automatically downloaded in the background”. FIG. 7(c) schematically shows a state of the media data transmission performed by the mobile terminal. When the first identifier 2011a is in a waiting-for-transmission state, the second identifier 2011b displays “Waiting for new pictures, and they will be automatically downloaded”. In this implementation, since the first identifier 2011a can display a specific state of the execution progress of the media data transmission, it is convenient for the user to know which media data has been transmitted to the second application module.

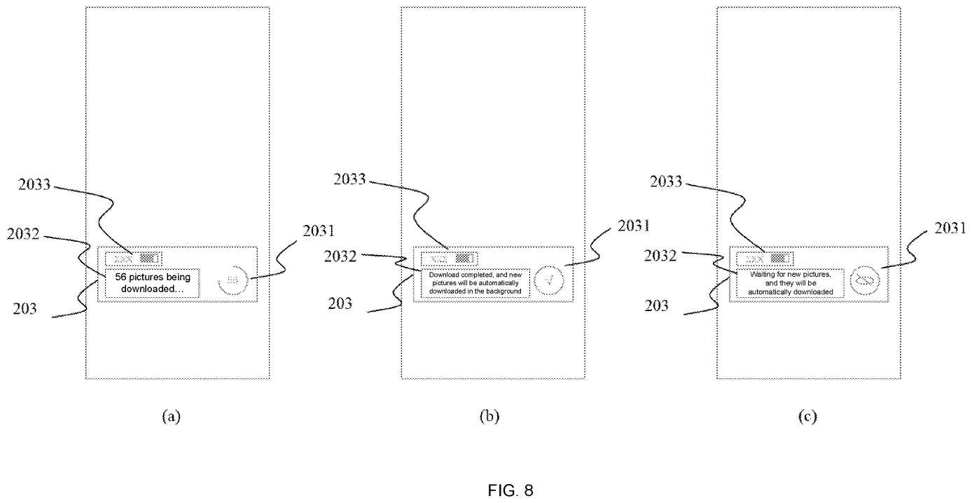

When the first application module runs in the background of the mobile terminal, the execution progress is displayed in a second display manner. For example, as shown in FIG. 8, the second display manner includes a second display bar 203 displayed on the mobile terminal (for example, in the screen-locked state or overlaid on other Apps). The second display bar 203 is configured to specifically display the execution progress of the media data transmission when the first application module 201 is in the background. Specifically, the second display bar 203 includes a first identifier 2031, a second identifier 2032, and a third identifier 2033. The first identifier 2031 corresponds to different symbols based on different states of the execution progress of the media data transmission. The second identifier 2032 corresponds to the first identifier 2031 and is configured to display text content corresponding to an execution progress symbol of the first identifier 2031. The third identifier 2033 is configured to display basic parameter information of the media data obtaining apparatus (such as a battery level and available duration). In some implementations, FIG. 8(a) schematically shows a state of the media data transmission performed by the mobile terminal. When the first identifier is in an open state, the second identifier displays “X pictures being downloaded . . . ”. FIG. 8(b) schematically shows a state of the media data transmission performed by the mobile terminal. When the first identifier is in a checked state, the second identifier displays “Download completed, and new pictures will be automatically downloaded in the background”. FIG. 8(c) schematically shows a state of the media data transmission performed by the mobile terminal. When the first identifier 2031 is in a waiting-for-transmission state, the second identifier displays “Waiting for new pictures, and they will be automatically downloaded”. In this implementation, since the first identifier 2033 can display a specific state of the execution progress of the media data transmission, it is convenient for the user to know which media data has been transmitted to the second application module. Meanwhile, since the second display bar 203 further includes the third identifier 2033, the user can quickly know the parameter information of the media data obtaining apparatus while browsing the execution progress of the media data transmission, which helps to improve user experience.

Furthermore, in some implementations, the S1021 further includes:
automatically receiving the media data generated by the media data obtaining apparatus 10 when the automatic sending function of the media data obtaining apparatus 10 is enabled.

In this implementation, when the automatic sending function of the media data obtaining apparatus 10 is enabled, the first application module can automatically receive the media data generated by the media data obtaining apparatus 10. In other words, the first application module can automatically obtain a new photo generated by the media data obtaining apparatus only after the media data obtaining apparatus 10 takes the new photo and transmits the new photo automatically. Accordingly, the user neither needs to make a selection on the first application module, nor needs to keep the first application module in a foreground state when performing photographing using the media data obtaining apparatus 10. In this implementation, the user may choose to enable or disable the automatic sending function, which preserves the user's freedom of selection on a camera side. The user may choose to enable or disable a function of automatically transmitting the new picture from the camera to the first application module, thereby preventing an unwanted picture from being downloaded to the system album of the terminal. In some implementations, dedicated physical hardware may be further provided on the media data obtaining apparatus 10 for the user to select whether to automatically transmit a captured picture to the mobile terminal.

In some implementations, after the media data obtaining apparatus 10 generates the new media data, the new media data is automatically stored in a high efficiency image file format (HEIF). In this way, data stored in the media data obtaining apparatus can be automatically sent to the first application module without requiring the user to make a selection on the media data obtaining apparatus. In other words, it is precisely because the media data is stored in this HEIF that a memory size occupied by a photo generated by the media data obtaining apparatus is reduced, allowing for automatic sending of the photo without requiring the user to make a selection in this regard.

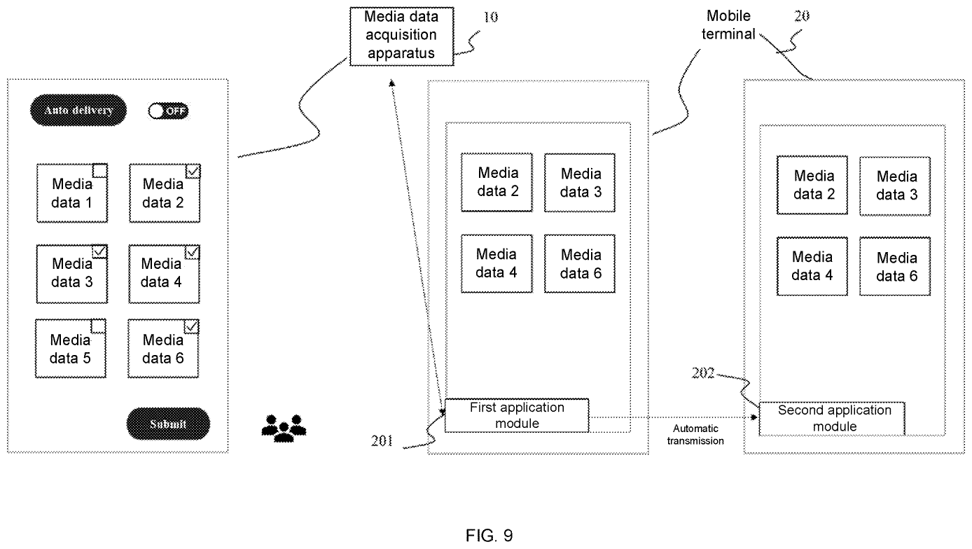

As shown in FIG. 9, in some implementations, before the S102, the media data transmission method further includes:
receiving the media data generated by the media data obtaining apparatus 10 after the media data obtaining apparatus 10 receives a sending instruction from the user.

Specifically, the media data is sent to the first application module 201 only after the user clicks the sending instruction on the media data obtaining apparatus 10. That is, the first application module 201 receives the media data generated by the media data obtaining apparatus 10 only after the media data obtaining apparatus 10 receives the sending instruction clicked by the user. Thus, the user can select and send to-be-retained media data on the media data obtaining apparatus, thereby avoiding a subsequent deletion operation on the system album. In some implementations, the user may select to-be-transmitted media data piece by piece, or select to-be-transmitted media data in batches through dragging. This is not limited in the present disclosure.

Furthermore, beneficial effects of this implementation are further described below. In the related art, the user is required to perform a selection operation on the first application module; whereas in this implementation, the user can perform the selection operation directly on the media data obtaining apparatus. Advantages of this implementation are as follows: when using the media data obtaining apparatus, for example, the digital camera, to take a photo, the user generally prefers to hold as few devices as possible. If the user still needs to perform picture selection and feedback on the mobile phone as in the related art, the user experience will be greatly degraded. By leveraging practical advantages of using the digital camera, a degree of freedom for the user to select a picture can be improved to the camera side, thereby enabling the user to obtain exactly what is captured.

In some implementations, a media data transmission method is applied to a media data obtaining apparatus, where the media data obtaining apparatus communicates with a first application module of a mobile terminal, the first application module is communicatively connected to a second application module of the mobile terminal, and the media data transmission method includes the following steps:
S201: Obtain a media data obtaining instruction from a user, and generate media data.
S202: Send the media data to the first application module of the mobile terminal.
S203: The first application module automatically transmits the media data to the second application module, where a data access permission of the second application module is higher than that of the first application module.

In this implementation, an execution body may be the media data obtaining apparatus. When the media data obtaining apparatus detects the media data obtaining instruction from the user, for example, when the user presses a shutter and new media data is generated, the media data obtaining apparatus sends the new media data to the first application module, such that after receiving the new media data, the first application module automatically sends the media data to the second application module. Specifically, the media obtaining apparatus is a camera, the mobile terminal is a mobile phone, the first application module is a camera App, and the second application module is a system album of the mobile phone. It should be noted that the camera App in the present disclosure is not a built-in system camera App of the mobile phone, but an App for controlling third-party hardware (e.g., a digital camera and an action camera). Implementations of the remaining parts are similar to those in the scheme in which the execution body is the first application module, and details are not described herein again. In some implementations, the S202 may further include the following step:
S2021: Automatically send the media data to the first application module.

In some implementations, the S2021 may further include:
automatically sending the media data generated by the media data obtaining apparatus to the first application module when an automatic sending function of the media data obtaining apparatus is enabled.

In some exemplary embodiments, before the S202, the media data transmission method further includes:
sending the media data to the first application module after the media data obtaining apparatus receives a sending instruction from the user.

These implementations have similar beneficial effects to those described in the foregoing implementations, and details are not described herein again.

In some implementations, a media data transmission method is applied to a second application module of a mobile terminal, where the second application module is communicatively connected to a first application module of the mobile terminal, the first application module is configured to communicate with a media data obtaining apparatus, and the media data transmission method includes the following step:
S301: Respond to that the first application module receives media data generated by the media data obtaining apparatus, and automatically receive the media data sent by the first application module, where a data access permission of the second application module is higher than that of the first application module.

In this implementation, an execution body may be the second application module. When it is detected that new media data is generated on a side where the media data obtaining apparatus is located, for example, when a user takes a new photo using the media data obtaining apparatus, the media data is sent to the first application module, and after the first application module automatically sends the media data, the second application module automatically receives the media data sent by the first application module. Specifically, the media obtaining apparatus is a camera, the mobile terminal is a mobile phone, the first application module is a camera App, and the second application module is a system album of the mobile phone. It should be noted that the camera App in the present disclosure is not a built-in system camera App of the mobile phone, but an App for controlling third-party hardware (e.g., a digital camera and an action camera). Implementations of the remaining parts are similar to those in the scheme in which the execution body is the first application module, and details are not described herein again.

In some implementations, that the first application module receives media data generated by the media data obtaining apparatus includes: the first application module automatically receives the media data generated by the media data obtaining apparatus. Furthermore, that the first application module automatically receives the media data generated by the media data obtaining apparatus includes: the first application module automatically receives the media data generated by the media data obtaining apparatus when an automatic sending function of the media data obtaining apparatus is enabled.

In some implementations, before the first application module receives the media data generated by the media data obtaining apparatus, the media data transmission method further includes: receiving, by the first application module, the media data generated by the media data obtaining apparatus after the media data obtaining apparatus receives a sending instruction from the user.

These implementations have similar beneficial effects to those described in the foregoing implementations, and details are not described herein again.

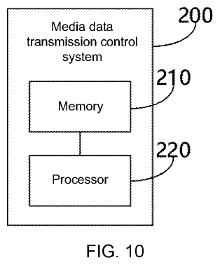

Referring to FIG. 10, a media data transmission control system 200 in the present disclosure may include a memory 210 and a processor 220. The memory 210 is configured to store a computer program. The processor 220 is configured to execute the computer program to perform the steps of the media data transmission method in any one of the above implementations.

For example, the computer program can be executed to perform the following steps:
S101: Respond to generation of media data by a media data obtaining apparatus.
S102: Receive the media data generated by the media data obtaining apparatus.
S103: Automatically send the media data to a second application module of a mobile terminal, where a data access permission of the second application module is higher than that of a first application module.

In addition, the computer program can be executed to perform the following steps:
S201: Obtain a media data obtaining instruction from a user, and generate media data.
S202: Send the media data to the first application module.
S203: The first application module automatically transmits the media data to the second application module, where a data access permission of the second application module is higher than that of the first application module.

In addition, the computer program can be executed to perform the following step:
S301: Respond to that the first application module receives media data generated by the media data obtaining apparatus, and automatically receive the media data sent by the first application module, where a data access permission of the second application module is higher than that of the first application module.

A computer-readable storage medium in the present disclosure stores a computer program. The computer program is executed by a processor 220 to perform the steps of the control method for a movable object in any one of the above implementations.

For example, the computer program can be executed to perform the following steps:
S101: Respond to generation of media data by a media data obtaining apparatus.
S102: Receive the media data generated by the media data obtaining apparatus.
S103: Automatically send the media data to a second application module, where a data access permission of the second application module is higher than that of a first application module.

In addition, the computer program can be executed to perform the following steps:
S201: Obtain a media data obtaining instruction from a user, and generate media data.
S202: Send the media data to the first application module.
S203: The first application module automatically transmits the media data to the second application module, where a data access permission of the second application module is higher than that of the first application module.

In addition, the computer program can be executed to perform the following step:
S301: Respond to that the first application module receives media data generated by the media data obtaining apparatus, and automatically receive the media data sent by the first application module, where a data access permission of the second application module is higher than that of the first application module.

In the above media data transmission method, when a media data obtaining apparatus generates new media data, a first application module of a mobile terminal can automatically send the received media data to a second application module of the mobile terminal. Therefore, a user does not need to manually select to-be-downloaded media data in the first application module, and any media data generated on the media data obtaining apparatus can be automatically downloaded to the second application module. Since a data access permission of the second application module is higher than that of the first application module, a media data processing App of the mobile terminal can directly access media data on the second application module, thereby improving user experience.

In some exemplary embodiments, in some implementations of the present disclosure, since a picture is automatically saved to a system album after being taken without requiring a user operation, a photo taken by a camera will be automatically downloaded to the system album even when the user runs an App in a background, locks a screen, and puts the mobile terminal in a pocket, thereby enabling the user to focus on camera photographing. A new picture taken by the camera is stored in an HEIF, and thus can be automatically transmitted to an App side, thereby avoiding excessive occupation of terminal memory. Since the user's freedom of selection on a camera side is preserved, the user may choose to enable or disable a function of automatically transmitting the new picture from the camera to the App side, thereby preventing an unwanted picture from being downloaded to the system album of the terminal.

The computer-readable storage medium may be disposed on the camera or on the mobile terminal. This is not limited in the present disclosure.

It can be understood that the computer-readable storage medium may include any physical entity or apparatus capable of carrying the computer program, a recording medium, a universal serial bus (USB) disk, a removable hard disk, a magnetic disk, an optical disc, a computer memory, a read-only memory (ROM), a random access memory (RAM), a software distribution medium, and the like. The computer program includes computer program code. The computer program code may be in a form of source code, a form of object code, an executable file or some intermediate forms, and the like.

In some cases of the present disclosure, the processor may be a central processing unit (CPU), may be a graphic processing unit (GPU), and may also be another general-purpose processor, a digital signal processor (DSP), an application specific integrated circuit (ASIC), a field-programmable gate array (FPGA) or another programmable logic device, a discrete gate or transistor logic device, a discrete hardware component, or the like.

Any process or method description in the flowchart or described in other manners herein can be understood as a module, a segment, or a part of code that includes one or more executable instructions for implementing steps of a specific logical function or process. In addition, a scope of the present disclosure includes additional implementations, and the functions may not be performed in the shown or discussed sequence, but may be executed in a basically same manner or according to a reverse sequence. This should be understood by a person skilled in the art to which the embodiments of the present disclosure belong.

The logic and/or steps represented in the flowchart or described in other manners herein, for example, may be considered as a sequenced list of executable instructions for implementing logical functions, and may be specifically implemented in any computer-readable medium, for use by instruction execution systems, apparatuses, or devices (such as computer-based systems, systems including processors, or other systems that can fetch instructions from the instruction execution systems, apparatuses, or devices and execute the instructions), or used in combination with these instruction execution systems, apparatuses, or devices.

In addition, the terms “first” and “second” are merely intended for a purpose of description, and shall not be understood as an indication or implication of relative importance or implicit indication of a quantity of indicated technical features. Therefore, the features defined by “first” and “second” can explicitly or implicitly include one or more of the features. In the description of the present disclosure, “a plurality of” means two or more, unless otherwise specifically defined.

In the description of the present disclosure, it should be understood that orientations or positional relationships indicated by terms (such as “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, and “counterclockwise”) are based on the accompanying drawings, for ease of describing the present disclosure and understanding a corresponding situation only, rather than indicating or implying that the indicated apparatus or element must have a particular orientation or be constructed and operated in a particular orientation. Therefore, these terms cannot be construed as a limitation to the present disclosure.

In the description of the present disclosure, unless otherwise expressly specified and defined, that a first feature is “above” or “under” a second feature may include that the first feature is in direct contact with the second feature, or that the first feature and the second feature are not in direct contact with each other but are in contact by using another feature between them. In addition, that the first feature is “over”, “above”, and “on” the second feature includes that the first feature is directly above and diagonally above the second feature, or simply indicates that a horizontal height of the first feature is higher than that of the second feature. That the first feature is “under” and “below” the second feature includes that the first feature is directly under or obliquely under the second feature, or simply indicates that the horizontal height of the first feature is less than that of the second feature.

Although the present disclosure has been illustrated and described, a person of ordinary skill in the art can understand that various changes, modifications, replacements, and variants may be made to the present disclosure without departing from the principle and purpose of the present disclosure, and the scope of the present disclosure is defined by the claims and equivalents thereof.

What is claimed is

1. A media data transmission method, comprising:
generating, by a media data obtaining apparatus, media data, wherein the media data transmission method is applied to a first application module of a mobile terminal, the mobile terminal further comprises a second application module, the second application module is communicatively connected to the first application module, and the first application module is configured to communicate with the media data obtaining apparatus;
in response to the generating of the media data, receiving the media data; and
automatically sending the media data to the second application module of the mobile terminal, wherein a data access permission of the second application module is higher than a data access permission of the first application module.

2. The media data transmission method according to claim 1, wherein the receiving of the media data comprises:
automatically receiving the media data generated by the media data obtaining apparatus.

3. The media data transmission method according to claim 1, further comprising:
prior to the receiving of the media data, receiving the media data generated by the media data obtaining apparatus in response to the media data obtaining apparatus receiving a sending instruction from a user.

4. The media data transmission method according to claim 2, wherein the automatically receiving of the media data generated by the media data obtaining apparatus comprises:
automatically receiving the media data generated by the media data obtaining apparatus in response to enabling an automatic sending function of the media data obtaining apparatus.

5. The media data transmission method according to claim 1, wherein the first application module has a background running permission of the mobile terminal.

6. The media data transmission method according to claim 5, wherein
prior to receiving the media data generated by the media data obtaining apparatus,
the first application module obtains the background running permission of the mobile terminal.

7. The media data transmission method according to claim 1, wherein the first application module obtains a background running permission of the mobile terminal when the first application module is installed on the mobile terminal.

8. The media data transmission method according to claim 1, wherein data of the second application module is configured to be accessed, edited, or processed by a media data processing application (App).

9. The media data transmission method according to claim 1, wherein the media data obtaining apparatus is configured to be independent of the mobile terminal.

10. The media data transmission method according to claim 9, wherein a communication mode between the media data obtaining apparatus and the first application module is wireless communication.

11. The media data transmission method according to claim 1, wherein the media data obtained by the media data obtaining apparatus is stored in a high efficiency image file format (HEIF).

12. The media data transmission method according to claim 1, wherein the mobile terminal displays an execution progress of media data transmission.

13. The media data transmission method according to claim 12, wherein when the first application module runs in a foreground of the mobile terminal, the execution progress is displayed in a first display manner; or when the first application module runs in a background of the mobile terminal, the execution progress is displayed in a second display manner.

14. The media data transmission method according to claim 1, wherein the media data obtaining apparatus is a digital camera, and the second application module is a system database of the mobile terminal.

15. The media data transmission method according claim 1, wherein the media data is picture data, audio data, or video data.

16. A media data transmission method, comprising:
obtaining a media data obtaining instruction from a user, and generating media data, wherein the media data transmission method is applied to a media data obtaining apparatus, the media data obtaining apparatus communicates with a first application module of a mobile terminal, and the first application module is communicatively connected to a second application module of the mobile terminal;
sending the media data to the first application module of the mobile terminal; and
automatically transmitting, by the first application module, the media data to the second application module, wherein a data access permission of the second application module is higher than a data access permission of the first application module.

17. The media data transmission method according to claim 16, wherein the sending of the media data to the first application module of the mobile terminal comprises:
automatically sending the media data to the first application module.

18. The media data transmission method according to claim 17, wherein the automatically sending of the media data to the first application module further comprises:
automatically sending the media data generated by the media data obtaining apparatus to the first application module in response to enabling an automatic sending function of the media data obtaining apparatus.

19. The media data transmission method according to claim 16, further comprising:
prior to sending the media data to the first application module of the mobile terminal, sending the media data to the first application module in response to the media data obtaining apparatus receiving a sending instruction from the user.

20. A media data transmission control system, comprising:
at least one storage medium storing at least one set of instructions; and
at least one processor in communication with the at least one storage medium, wherein during operation, the at least one processor executes the at least one set of instructions to cause the media data transmission control system to perform at least one of Process A or Process B:
Process A: generating, by a media data obtaining apparatus, media data, wherein the media data transmission method is applied to a first application module of a mobile terminal, the mobile terminal further comprises a second application module, the second application module is communicatively connected to the first application module, and the first application module is configured to communicate with the media data obtaining apparatus; in response to the generating of the media data, receiving the media data; and automatically sending the media data to the second application module of the mobile terminal, wherein a data access permission of the second application module is higher than a data access permission of the first application module;
Process B: obtaining a media data obtaining instruction from a user, and generating media data, wherein the media data transmission method is applied to a media data obtaining apparatus, the media data obtaining apparatus communicates with a first application module of a mobile terminal, and the first application module is communicatively connected to a second application module of the mobile terminal; sending the media data to the first application module of the mobile terminal; and automatically transmitting, by the first application module, the media data to the second application module, wherein a data access permission of the second application module is higher than a data access permission of the first application module.
